(19) United States
(12) Patent Application Publication
(10) Pub. No.: US 2025/0380748 A1
(43) Pub. Date: Dec. 18, 2025

(54) AEROSOL GENERATING DEVICE AND METHOD OF DETERMINING STATE OF AEROSOL GENERATING ARTICLE

(71) Applicant: KT&G Corporation, Daejeon (KR)

(72) Inventors: Minseok JEONG, Seoul (KR); Jong Sub LEE, Gyeonggi-do (KR); Byungsung CHO, Gyeonggi-do (KR)

(73) Assignee: KT&G Corporation, Daejeon (KR)

(21) Appl. No.: 19/092,460

(22) Filed: Mar. 27, 2025

(30) Foreign Application Priority Data
Jun. 13, 2024 (KR) 10-2024-0077123

(51) Int. Cl. A24F 40/53; A24F 40/10; A24F 40/20; A24F 40/30; A24F 40/465; A24F 40/485; A24F 40/51; A24F 40/65

(52) U.S. Cl. CPC A24F 40/53; A24F 40/51; A24F 40/10; A24F 40/20; A24F 40/30; A24F 40/465; A24F 40/485; A24F 40/65

(57) ABSTRACT

An aerosol generating device includes a housing including an inner space, a first sensor disposed adjacent to the inner space, a second sensor disposed adjacent to the inner space at a position different from that of the first sensor, and a controller that is accommodated by the housing and includes at least one processor, in which the controller is configured to determine whether the aerosol generating article is over-humidified based on first information received from the first sensor and determine whether the aerosol generating article is reused based on second information received from the second sensor.

### CROSS-REFERENCE TO RELATED APPLICATION

This application claims the benefit of Korean Patent Application No. 10-2024-0077123, filed on Jun. 13, 2024, in the Korean Intellectual Property Office, the entire disclosure of which is incorporated herein by reference for all purposes.

### BACKGROUND

### 1. Field of the Invention

One or more embodiments relate to an aerosol generating device and a method of determining the state of an aerosol generating article.

### 2. Description of the Related Art

Research on non-combusted cigarettes is being carried out. An aerosol generating device generates an aerosol by heating an aerosol generating article.

Additional aspects of embodiments will be set forth in part in the description which follows and, in part, will be apparent from the description, or may be learned by practice of the disclosure.

### SUMMARY

Embodiments provide an aerosol generating device for effectively determining whether an aerosol generating article is reused and an aerosol generating system including the same.

Embodiments provide an aerosol generating device for accurately determining whether an aerosol generating article is reused even in an over-humidified state and an aerosol generating system including the same.

Embodiments provide an aerosol generating device for effectively determining whether an aerosol generating article is over-humidified and an aerosol generating system including the same.

Embodiments provide an aerosol generating device for effectively determining or verifying the type of aerosol generating article and an aerosol generating system including the same.

Embodiments provide an aerosol generating device for providing optimal smoking satisfaction to a user by using the state of an aerosol generating article and an aerosol generating system including the same.

According to an aspect, there is provided an aerosol generating device including a housing including a first surface, a second surface that is opposite to the first surface, and a side surface between the first surface and the second surface, in which an inner space into which an aerosol generating article is inserted is formed on the first surface, a first sensor disposed adjacent to the inner space, a second sensor disposed adjacent to the inner space at a position different from that of the first sensor, and a controller that is accommodated by the housing and includes at least one processor, in which the controller is configured to determine whether the aerosol generating article is over-humidified based on first information received from the first sensor and determine whether the aerosol generating article is reused based on second information received from the second sensor.

According to another aspect, there is provided a method of determining a state of an aerosol generating article including providing the aerosol generating article including a first filter segment, a medium segment that is disposed in a downstream of the first filter segment and configured to accommodate a medium, and a second filter segment that is disposed in a downstream of the medium segment, measuring a capacitance variance of the medium segment of the aerosol generating article by a first capacitive sensor, measuring a capacitance variance of the first filter segment by a second capacitive sensor, and determining whether the aerosol generating article is reused based on the capacitance variances.

According to embodiments, whether an aerosol generating article that is usable in unheated conditions is reused may be determined effectively.

According to embodiments, whether an aerosol generating article is reused may be determined accurately even in over-humidified conditions.

According to embodiments, an aerosol generating article being in an over-humidified state may be effectively determined.

According to embodiments, the type of aerosol generating article inserted in an aerosol generating device may be determined or verified effectively.

According to Embodiments, optimal smoking satisfaction may be provided to a user by using the state of an aerosol generating article.

The effects of the aerosol generating device and the aerosol generating system including the same are not limited to the above-mentioned effects, and other unmentioned effects may be clearly understood by one of ordinary skill in the art from the following descriptions.

### BRIEF DESCRIPTION OF THE DRAWINGS

FIG. 1 is a diagram illustrating an aerosol generating system according to an embodiment.

FIG. 2 is a diagram illustrating an aerosol generating system according to an embodiment.

FIG. 3 is a block diagram illustrating an aerosol generating device according to an embodiment.

FIG. 4 is a view schematically illustrating the structure of an aerosol generating article included in an aerosol generating system according to an embodiment.

FIG. 5 is an exploded view illustrating a portion of an aerosol generating device according to an embodiment.

FIG. 6 is an exploded view illustrating the state of an aerosol generating article inserted in a portion of an aerosol generating device according to an embodiment.

FIG. 7 is a flowchart illustrating a method of determining the state of an aerosol generating article according to an embodiment.

FIG. 8 is an exploded view illustrating a portion of an aerosol generating device according to an embodiment.

FIG. 9 is a diagram illustrating an aerosol generating system according to an embodiment.

FIG. 10 is a diagram illustrating an aerosol generating system according to an embodiment.

FIG. 11 is a diagram illustrating an aerosol generating system according to an embodiment.

FIG. 12 is a diagram illustrating an aerosol generating system according to an embodiment.

### DETAILED DESCRIPTION

The terms used in the embodiments are selected from among common terms that are currently widely used, in consideration of their function in the embodiments. However, the terms may become different according to an intention of one of ordinary skill in the art, a precedent, or the advent of new technology. Also, in particular cases, the terms are discretionally selected by the applicant of the disclosure, and the meaning of those terms will be described in detail in the corresponding part of the detailed description. Therefore, the terms used in the disclosure are not merely designations of the terms, but the terms are defined based on the meaning of the terms and content throughout the disclosure.

It will be understood that when a certain part “includes” a certain component, the part does not exclude another component but may further include another component, unless the context clearly dictates otherwise. Also, terms such as “unit,” “module,” etc., as used in the specification may refer to a part for processing at least one function or operation and may be implemented as hardware, software, or a combination of hardware and software.

As used herein, an expression such as “at least one of” that precedes listed components modifies not each of the listed components but all the components. For example, the expression “at least one of a, b, or c” should be construed as including a, b, c, a and b, a and c, b and c, or a, b, and c.

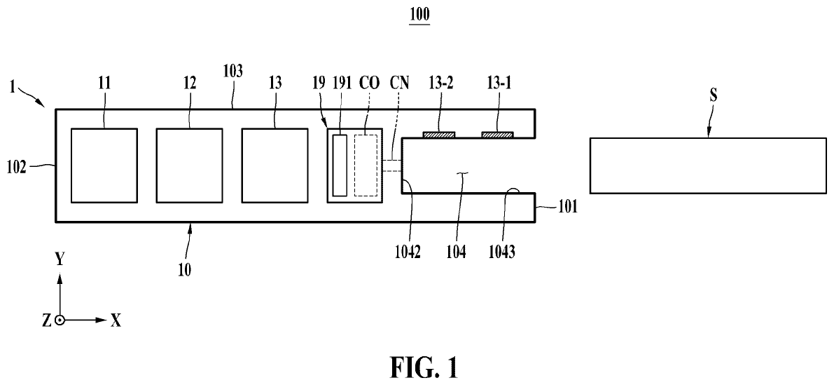

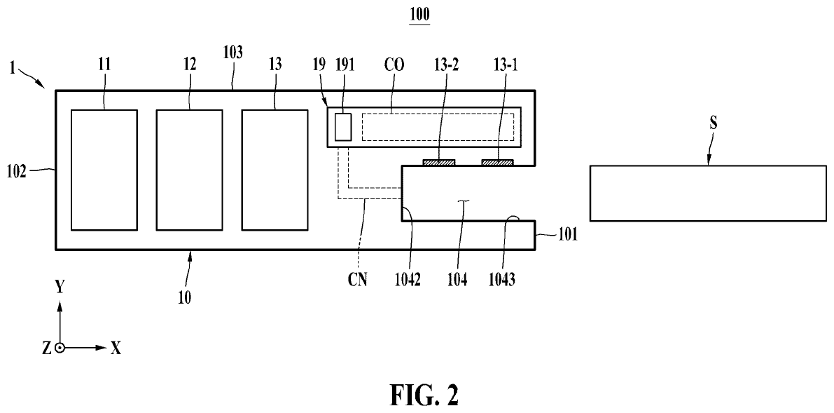

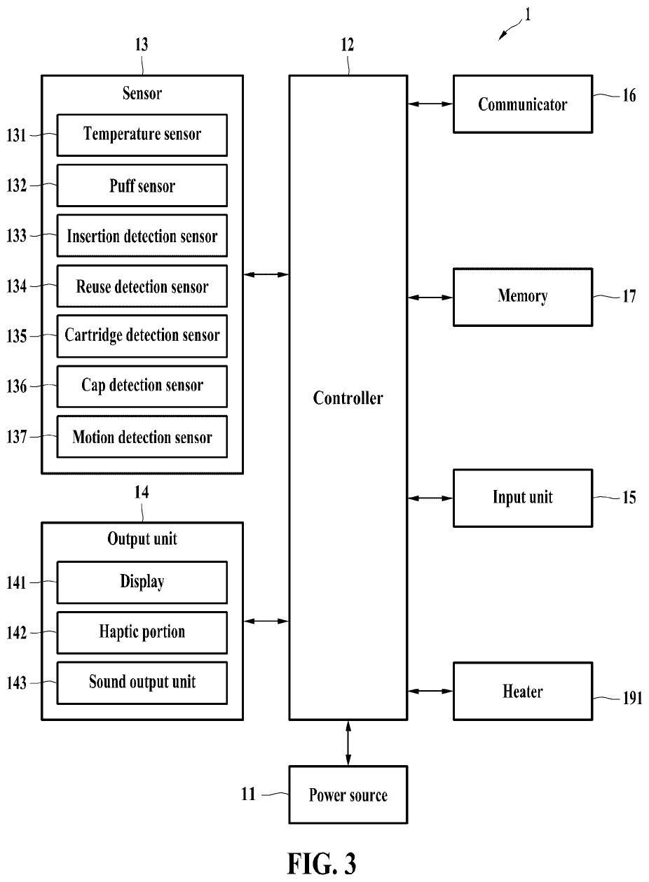

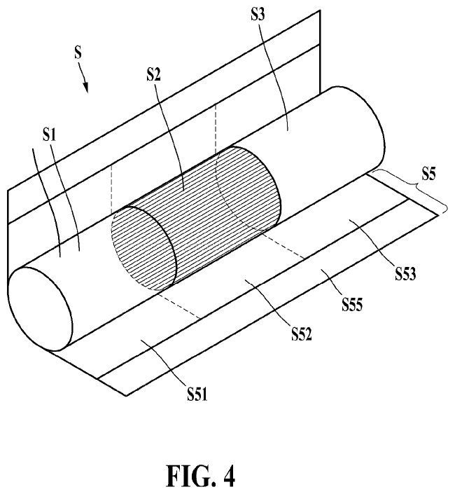

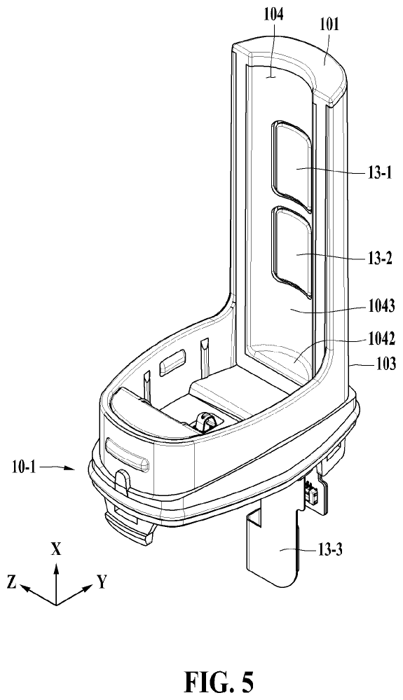

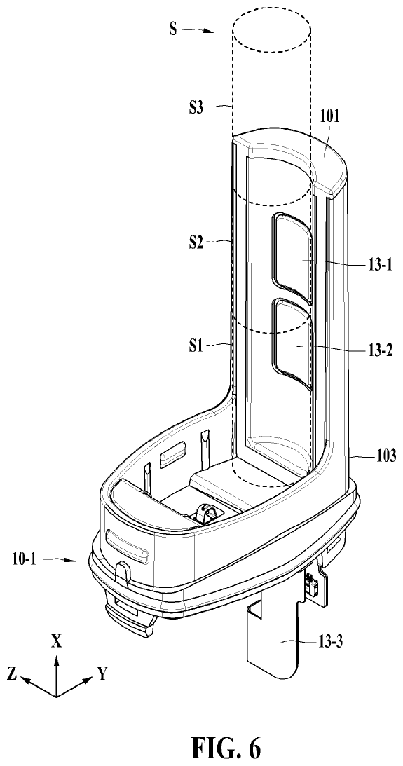

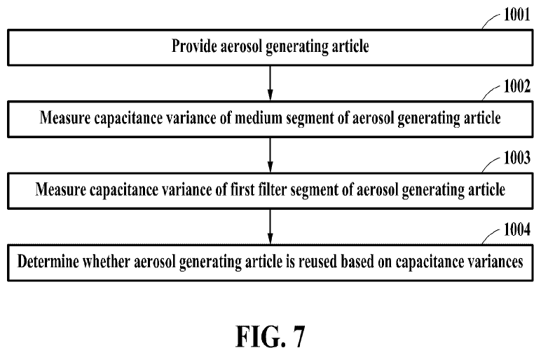

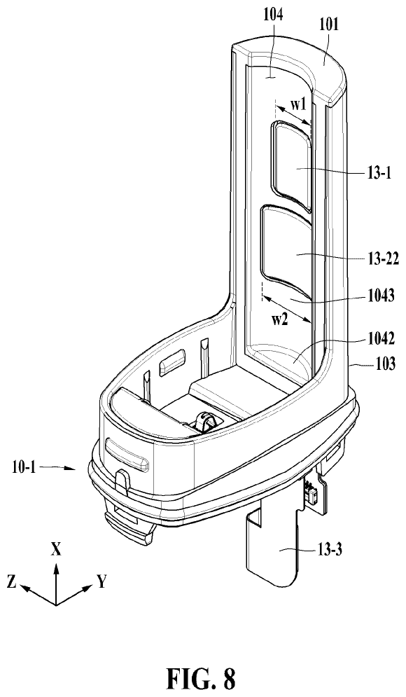

FIGS. 1 and 2 each illustrate an aerosol generating system according to an embodiment. FIG. 3 is a block diagram of an aerosol generating device according to an embodiment. FIG. 4 is a view schematically illustrating the structure of an aerosol generating article included in an aerosol generating system according to an embodiment. FIG. 5 is an exploded view illustrating a portion of an aerosol generating device according to an embodiment, and FIG. 6 is an exploded view illustrating an aerosol generating article inserted into a portion of an aerosol generating device according to an embodiment. FIG. 7 is a flowchart illustrating a method of determining the state of an aerosol generating article according to an embodiment. FIG. 8 is an exploded view illustrating a portion of an aerosol generating device according to an embodiment.

Referring to FIGS. 1 to 4, an aerosol generating system 100, according to an embodiment, may include an aerosol generating device 1 and an aerosol generating article S.

Referring to FIGS. 1 and 2, the aerosol generating device 1 may include at least one of a power source 11, a controller 12, a sensor 13, and a vaporizer 19. At least one of the power source 11, the controller 12, and the sensor 13 may be disposed inside a housing 10 of the aerosol generating device 1. The housing 10 may provide a single side opening space into which the aerosol generating article S is inserted. The single side opening space may be referred to as an inner space 104. The inner space 104 may be recessed by a predetermined depth toward the inside of the housing 10 such that at least a portion of the aerosol generating article S may be inserted into the inner space 104. The depth of the inner space may correspond to the length of an area of the aerosol generating article S in which an aerosol generating material and/or medium is included. An upper end of the aerosol generating article S may be inserted into the housing 10, and a lower end of the aerosol generating article S may protrude outward from the housing 10. A user may hold the lower end of the aerosol generating article S, which is exposed to the outside, in the mouth of the user and inhale air.

The vaporizer 19 may contain an aerosol generating material having any one of a liquid state, a solid state, a gaseous state, or a gel state. The aerosol generating material may include a liquid composition. The liquid composition may be, for example, a liquid including a tobacco-containing material that includes a volatile tobacco flavor component or may be a liquid including a non-tobacco material. The liquid composition may include, for example, at least one of glycerin, propylene glycol, ethylene glycol, dipropylene glycol, diethylene glycol, triethylene glycol, tetraethylene glycol, or oleyl alcohol. However, embodiments are not limited thereto. The vaporizer 19 may be formed integrally with the housing 10 or detachably coupled to the housing 10.

For example, referring to FIG. 1, the vaporizer 19 may be formed integrally with the housing 10 and may communicate with the inner space 104 through an airflow channel CN.

For example, referring to FIG. 2, a space may be formed on one side of the housing 10, at least a portion of the vaporizer 19 is inserted into the space formed on one side of the housing 10, and the vaporizer 19 may be mounted on the housing 10. The airflow channel CN may be defined by a portion of the vaporizer 19 and/or a portion of the housing 10, and the vaporizer 19 may communicate with the inner space 104 through the airflow channel CN.

The housing 10 may be formed in a structure in which the outside air may be introduced into the interior of the housing 10 while the vaporizer 19 is inserted thereinto. In this case, the external air entering the housing 10 may pass through the vaporizer 19 and flow into the oral cavity of a user.

The vaporizer 19 may include a storage CO, which contains an aerosol generating material, and/or a heater 191 for heating the aerosol generating material in the storage CO. A liquid transfer means impregnated with (containing) the aerosol generating material may be disposed inside the storage CO. Here, the liquid transfer means may include a wick, such as a cotton fiber, a ceramic fiber, a glass fiber, or a porous ceramic, and the like. An electrically conductive track of the heater 191 may be formed having a coil-type structure that is wound around the liquid transfer means or a structure that is in contact with one side of the liquid transfer means. The heater 191 may be referred to as a vaporizer heater 191.

The vaporizer 19 may generate an aerosol. The aerosol may be generated as the liquid transfer means is heated by the vaporizer heater 191. While the aerosol generated by the vaporizer heater 191 passes through the aerosol generating article S, a tobacco material may be added to the aerosol. The aerosol with the tobacco material may be inhaled into the oral cavity of the user through one end of the aerosol generating article S.

The aerosol generating device 1 may include a cap (not shown). The cap may be detachably coupled to the housing 10 to cover at least a portion of the vaporizer 19 coupled to the housing 10. The aerosol generating article S may be inserted into the housing 10 by passing through the cap.

The power source 11 may supply power to operate the components of the aerosol generating device 1. The power source 11 may be referred to as the battery. The power source 11 may supply power to at least one of the controller 12, the sensor 13, and the vaporizer heater 191.

The controller 12 may control the overall operation of the aerosol generating device 1. The controller 12 may be mounted on a printed circuit board (PCB). The controller 12 may control the operation of at least one of the power source 11, the sensor 13, and the vaporizer 19. The controller 12 may control the operation of the display, a motor, and the like installed in the aerosol generating device 1. The controller 12 may verify a state of each of the components of the aerosol generating device 1 to determine whether the aerosol generating device 1 is in an operable state.

The controller 12 may analyze a sensing result obtained by the sensing of the sensor 13 and control processes to be performed thereafter. For example, the controller 12 may control power to be supplied to the vaporizer heater 191 to start or end an operation of the vaporizer heater 191 based on the sensing result obtained by the sensor 13. For example, the controller 12 may control an amount of power to be supplied to the vaporizer heater 191 and a time for which the power is to be supplied, such that the vaporizer heater 191 may be heated up to a predetermined temperature or maintained at a desired temperature, based on the sensing result obtained by the sensor 13.

The sensor 13 may include at least one of a temperature sensor, a puff sensor, an insertion detection sensor, a color sensor, a cartridge detection sensor, or a cap detection sensor. For example, the sensor 13 may sense at least one of the temperature of the vaporizer heater 191, the temperature of the power source 11, or the temperature inside and outside the housing 10. For example, the sensor 13 may sense a puff of the user. For example, the sensor 13 may sense whether the aerosol generating article S is inserted into the inner space 104. For example, the sensor 13 may sense whether the vaporizer 19 is mounted. For example, the sensor 13 may sense whether the cap is mounted.

The housing 10 may include a first surface 101, a second surface 102 opposite to the first surface 101, and a side surface 103 between the first surface 101 and the second surface 102. The inner space 104 may be formed on the first side 101. The inner space 104 may include an inner space end surface 1042 positioned between the first surface 101 and the second surface 102 and an inner space side surface 1043 extending from an edge of the inner space end surface 1042 to the first surface 101.

A first sensor 13-1 and a second sensor 13-2 may be arranged along a longitudinal direction (e.g., along a −X direction in FIGS. 1 and 2) of the inner space 104.

The controller 12 may receive first information sensed by the first sensor 13-1 and second information sensed by the second sensor 13-2 and may determine the state of the aerosol generating article S based on the first information and the second information. The first sensor 13-1 and the second sensor 13-2 are described in detail below.

Referring to FIG. 3, the aerosol generating device 1 may include the power source 11, the controller 12, the sensor 13, an output unit 14, an input unit 15, a communicator 16, a memory 17, and at least one heater 191. However, the internal structure of the aerosol generating device 1 is not limited to what is shown in FIG. 1 or 2. That is, it is to be understood by one of ordinary skill in the art to which the present embodiment pertains that some of the components shown in FIG. 1 or 2 may be omitted or new components may be added according to the design of the aerosol generating device 1.

The sensor 13 may sense a state of the aerosol generating device 1 or a state of an environment around the aerosol generating device 1 and transmit sensed information to the controller 12. Based on the sensed information, the controller 12 may control the aerosol generating device 1 to perform various functions, such as controlling the operation of the heater 191, restricting smoking, determining whether the aerosol generating article S and/or the vaporizer 19 is inserted, and displaying a notification.

The sensor 13 may include at least one of a temperature sensor 131, a puff sensor 132, an insertion detection sensor 133, a reuse detection sensor 134, a cartridge detection sensor (vaporizer detection sensor) 135, a cap detection sensor 136, and a motion detection sensor 137.

The temperature sensor 131 may sense a temperature at which the vaporizer heater 191 heats up. The aerosol generating device 1 may include a separate temperature sensor for sensing the temperature of the vaporizer heater 191, or the vaporizer heater 191 itself may perform a function as a temperature sensor.

The temperature sensor 131 may output a signal corresponding to the temperature of the vaporizer heater 191. For example, the temperature sensor 131 may include a resistive element whose resistance value changes in response to a change in the temperature of the vaporizer heater 191. The temperature sensor 131 may be implemented by a thermistor, which is an element that uses the property that the resistance changes depending on the temperature. In this case, the temperature sensor 131 may output a signal corresponding to the resistance value of the resistive element as the signal corresponding to the temperature of the vaporizer heater 191. For example, the temperature sensor 131 may include a sensor for detecting the resistance value of the vaporizer heater 191. In this case, the temperature sensor 131 may output a signal corresponding to the resistance value of the vaporizer heater 191 as the signal corresponding to the temperature of the vaporizer heater 191.

The temperature sensor 131 may be arranged around the power source 11 to monitor the temperature of the power source 11. The temperature sensor 131 may be disposed adjacent to the power source 11. For example, the temperature sensor 131 may be attached to one surface of a battery, which is the power source 11. For example, the temperature sensor 131 may be mounted on one surface of a PCB.

The temperature sensor 131 may be disposed inside of the housing 10 to sense the internal temperature of the housing 10.

The puff sensor 132 may sense a puff from a user based on various physical changes in an airflow path. The puff sensor 132 may output a signal corresponding to the puff. For example, the puff sensor 132 may be a pressure sensor. The puff sensor 132 may output a signal corresponding to the internal pressure of the aerosol generating device 1. Here, the internal pressure of the aerosol generating device 1 may correspond to the pressure in an airflow path through which a gas flows. The puff sensor 132 may be disposed corresponding to the airflow path through which a gas flows in the aerosol generating device 1.

The insertion detection sensor 133 may sense an insertion and/or removal of the aerosol generating article S. The insertion detection sensor 133 may sense a signal change according to the insertion and/or removal of the aerosol generating article S. The insertion detection sensor 133 may be installed in the vicinity of an insertion space. The insertion detection sensor 133 may sense the insertion and/or removal of the aerosol generating article S according to a change in the permittivity inside the insertion space. For example, the insertion detection sensor 133 may be an inductive sensor and/or a capacitance (capacitive) sensor.

The inductive sensor may include at least one coil. The coil of the inductive sensor may be disposed adjacent to an inner space. For example, if the magnetic field changes around the coil through which an electric current flows, the properties of the current flowing through the coil may change according to Faraday's law of electromagnetic induction. Here, the properties of the current flowing through the coil may include the frequency of alternating current, the current value, the voltage value, the inductance value, the impedance value, and the like.

The inductive sensor may output a signal corresponding to the properties of the current flowing through the coil. For example, the inductive sensor may output a signal corresponding to the inductance value of the coil.

The capacitance sensor may include a conductor. The conductor of the capacitance sensor may be disposed adjacent to the inner space (e.g., the inner space 104 of FIG. 1 or 2). The capacitance sensor may output a signal corresponding to the electromagnetic properties of the surroundings, for example, the capacitance around the conductor. For example, when the aerosol generating article S including a metal wrapper is inserted into the insertion space, the electromagnetic properties around the conductor may change due to the wrapper of the aerosol generating article S.

The reuse detection sensor 134 may sense whether the aerosol generating article S is reused. The reuse detection sensor 134 may be a color sensor. The color sensor may sense the color of the aerosol generating article S. The color sensor may sense the color of a portion of the wrapper that wraps around the outside of the aerosol generating article S. The color sensor may detect the value of the optical properties corresponding to the color of an object based on light reflected from the object. For example, the optical properties may be the wavelength of light. The color sensor may be implemented as a single component in conjunction with a proximity sensor or may be implemented as a separate component different from the proximity sensor.

At least a portion of the wrapper of the aerosol generating article S may change in color due to an aerosol. The reuse detection sensor 134 may be disposed at a position corresponding to the position at which at least a portion of the wrapper that changes in color due to an aerosol is disposed when the aerosol generating article S is inserted into the insertion space. For example, before the aerosol generating article S is used by the user, the color of at least a portion of the wrapper may be a first color. In this case, as at least a portion of the wrapper is wet by the aerosol while the aerosol generated by the aerosol generating device 1 passes through the aerosol generating article S, the color of the portion of the wrapper may change to a second color. Meanwhile, the color of the portion of the wrapper may be maintained as the second color after changing from the first color to the second color.

The cartridge (vaporizer) detection sensor 135 may sense the insertion and/or removal of the vaporizer 19. The cartridge detection sensor 135 may be implemented by an inductance-based sensor, a capacitive sensor, a resistance sensor, or a Hall sensor (e.g., Hall IC) using the Hall effect.

The cap detection sensor 136 may sense the mounting and/or removal of a cap. When the cap is detached from the housing 10, a portion of the vaporizer 19 and the housing 10 covered by the cap may be exposed to the outside. The cap detection sensor 136 may be implemented by a contact sensor, a Hall sensor (e.g., Hall IC), an optical sensor, or the like.

The motion detection sensor 137 may sense a motion of the aerosol generating device 1. The motion detection sensor 137 may be implemented by at least one of an acceleration sensor and a gyro sensor.

In addition to the sensors 131 to 137 described above, the sensor 13 may further include at least one of a humidity sensor, a barometric pressure sensor, a magnetic sensor, a position sensor (e.g., global positioning system (GPS)), and a proximity sensor. r. The function of each of the sensors may be intuitively inferable from its name by one of ordinary skill in the art, and thus, a more detailed description thereof will be omitted here.

The output unit 14 may output and provide information about the state of the aerosol generating device 1 to the user. The output unit 14 may include at least one of a display 141, a haptic portion 142, or a sound output unit 143, but is not limited thereto. When the display 141 and a touchpad are provided in a layered structure to form a touchscreen, the display 141 may be used as an input device in addition to an output device.

The display 141 may visually provide information about the aerosol generating device 1 to the user. The information about the aerosol generating device 1 may include, for example, a charging/discharging state of the power source 11 of the aerosol generating device 1, a preheating state of the heater 18, an insertion/removal state of the aerosol generating article S and/or the vaporizer 19, a mounting/removal state of the cap, or a limited usage state (e.g., an abnormal article detected) of the aerosol generating device 1, or the like, and the display 141 may externally output the information. For example, the display 141 may be in the form of a light-emitting diode (LED) device. The display 141 may be, for example, a liquid-crystal display panel (LCD), an organic light-emitting display panel (OLED), or the like.

The haptic portion 142 may provide information about the aerosol generating device 1 to the user in a haptic way by converting an electrical signal into a mechanical stimulus or an electrical stimulus. For example, the haptic portion 142 may generate vibrations corresponding to the completion of initial preheating when initial power is supplied to the vaporizer heater 191 for a set time. The haptic portion 142 may include, for example, a vibration motor, a piezoelectric element, or an electrical stimulation device.

The sound output unit 143 may provide information about the aerosol generating device 1 to the user in an auditory way. For example, the sound output unit 143 may convert an electrical signal into a sound signal and externally output the sound signal.

The power source 11 may supply power to be used to operate the aerosol generating device 1. The power source 11 may supply power to heat the vaporizer heater 191. In addition, the power source 11 may supply power required for operations of the other components (e.g., the sensor 13, the output unit 14, the input unit 15, the communication unit 16, and the memory 17) included in the aerosol generating device 1. The power source 11 may be a rechargeable battery or a disposable battery. The power source 11 may be, for example, a lithium polymer (LiPoly) battery, but is not limited thereto.

Although not shown in FIG. 3, the aerosol generating device 1 may further include a power protection circuit. The power protection circuit may be electrically connected to the power source 11 and may include a switching element.

The power protection circuit may cut off an electrical circuit for the power source 11 under a predetermined condition. For example, the power protection circuit may cut off the electrical circuit for the power source 11 when the voltage level of the power source 11 is greater than or equal to a first voltage corresponding to overcharging. For example, the power protection circuit may cut off the electrical circuit for the power source 11 when the voltage level of the power source 11 is less than a second voltage corresponding to over-discharging.

The controller 12, the sensor 13, the output unit 14, the input unit 15, the communication unit 16, and the memory 17 may receive power from the power source 11 to perform functions. Although not shown in FIG. 1 or 2, a power conversion circuit, for example, a low dropout (LDO) circuit or a voltage regulator circuit, which converts power of the power source 11 and supplies the power to respective components, may further be included. In addition, although not shown in FIG. 3, a noise filter may be provided between the power source 11 and the vaporizer heater 191. The noise filter may be a low-pass filter. The low-pass filter may include at least one inductor and at least one capacitor. The cutoff frequency of the low-pass filter may correspond to the frequency of a high-frequency switching current applied from the power source 11 to the vaporizer heater 191. The low-pass filter may prevent the application of a high-frequency noise component to the sensor 13, such as the insertion detection sensor 133.

In an embodiment, the vaporizer heater 191 may be formed of a predetermined electrically resistive material that is suitable. For example, the electrically resistive material may be a metal or a metal alloy including, for example, titanium, zirconium, tantalum, platinum, nickel, cobalt, chromium, hafnium, niobium, molybdenum, tungsten, tin, gallium, manganese, iron, copper, stainless steel, nichrome, or the like. However, embodiments are not limited thereto. In addition, the vaporizer heater 191 may be implemented as a metal heating wire, a metal heating plate on which an electrically conductive track is arranged, a ceramic heating element, or the like. However, embodiments are not limited thereto.

In another embodiment, the vaporizer heater 191 may be an induction heater. For example, the vaporizer heater 191 may include a susceptor that heats the aerosol generating material by generating heat through a magnetic field applied by a coil.

The input unit 15 may receive information input from the user or may output information to the user. For example, the input unit 15 may be a touch panel. The touch panel may include at least one touch sensor for sensing a touch. For example, the touch sensor may include a capacitive touch sensor, a resistive touch sensor, a surface acoustic wave touch sensor, an infrared touch sensor, and the like, but is not limited thereto.

The display 141 and the touch panel may be implemented as a single panel. For example, the touch panel may be inserted into the display 141 (e.g., an on-cell type or in-cell type). For example, the touch panel may be added onto the display panel 141 (e.g., an add-on type).

Meanwhile, the input unit 15 may include a button, a keypad, a dome switch, a jog wheel, a jog switch, and the like, but is not limited thereto.

The memory 17, which is hardware for storing various pieces of data processed in the aerosol generating device 1, may store data processed by the controller 12 and data to be processed thereby. The memory 17 may include at least one type of storage medium of a flash memory type memory, a hard disk type memory, a multimedia card micro type memory, a card type memory (e.g., an SD or XE memory), a random access memory (RAM), a static random access memory (SRAM), a read-only memory (ROM), an electrically erasable programmable read-only memory (EEPROM), a programmable read-only memory (PROM), a magnetic memory, a magnetic disk, or an optical disk. The memory 17 may store an operating time of the aerosol generating device 1, a maximum number of puffs, a current number of puffs, at least one temperature profile, data associated with a smoking pattern of the user, and the like.

The communication unit 16 may include at least one component for communicating with another electronic device. For example, the communication unit 16 may include at least one of a short-range wireless communication unit and a wireless communication unit.

The short-range wireless communication unit may include a Bluetooth communication unit, a Bluetooth low energy (BLE) communication unit, a near-field communication unit, a WLAN (Wi-Fi) communication unit, a ZigBee communication unit, an infrared data association (IrDA) communication unit, a Wi-Fi direct (WFD) communication unit, an ultra-wideband (UWB) communication unit, and an Ant+ communication unit, but is not limited thereto.

The wireless communication unit may include, for example, a cellular network communicator, an Internet communicator, a computer network (e.g., a local area network (LAN) or a wide-area network (WAN)) communicator, and the like, but is not limited thereto.

Although not shown in FIG. 3, the aerosol generating device 1 may further include a connection interface such as a universal serial bus (USB) interface and may be connected to another external device through the connection interface such as a USB interface to transmit and receive information or to charge the power source 11.

The controller 12 may control the overall operation of the aerosol generating device 1. In an embodiment, the controller 12 may include at least one processor. The at least one processor may be implemented as an array of a plurality of logic gates or may be implemented as a combination of a general-purpose microprocessor and a memory in which a program executable by the microprocessor is stored. In addition, it is to be understood by one of ordinary skill in the art to which the present disclosure pertains that it may be implemented in other types of hardware.

The controller 12 may control the temperature of the heater 18 by controlling the supply of power from the power source 11 to the vaporizer heater 191. The controller 12 may control the temperature of the vaporizer heater 191 based on the temperature of the vaporizer heater 191 sensed by the temperature sensor 131. The controller 12 may control the power supplied to the vaporizer heater 191 based on the temperature of the vaporizer heater 191. For example, the controller 12 may determine a target temperature for the vaporizer heater 191 based on a temperature profile stored in the memory 17.

The aerosol generating device 1 may include a power supply circuit (not shown) electrically connected to the power source 11 between the power source 11 and the vaporizer heater 191. The power supply circuit may be electrically connected to the vaporizer heater 191. The power supply circuit may contain at least one switching element. The switching element may be implemented by a bipolar junction transistor (BJT), a field effective transistor (FET), or the like. The controller 12 may control the power supply circuit.

The controller 12 may control the power supply by controlling the switching of the switching element of the power supply circuit. The power supply circuit may be an inverter for converting direct current (DC) power output from the power source 11 into alternating current (AC) power. For example, the inverter may include a half-bridge circuit or a full-bridge circuit including a plurality of switching elements.

The controller 12 may turn on the switching element to supply power from the power source 11 to the vaporizer heater 191. The controller 12 may turn off the switching element to cut off the supply of power to the vaporizer heater 191. The controller 12 may adjust the current supplied from the power source 11 by adjusting the frequency and/or duty ratio of the current pulse input to the switching element.

The controller 12 may control the voltage output from the power source 11 by controlling the switching of the switching element of the power supply circuit. A power conversion circuit may convert the voltage output from the power source 11. For example, the power conversion circuit may include a buck-converter for decreasing the voltage output from the power source 11. For example, the power conversion circuit may be implemented through a buck-boost converter, a Zener diode, or the like.

The controller 12 may adjust the level of voltage output from the power conversion circuit by controlling an ON/OFF operation of the switching element included in the power conversion circuit. During the ON state of the switching element, the level of voltage output from the power conversion circuit may correspond to the level of voltage output from the power source 11. The duty ratio for the ON/OFF operation of the switching element may correspond to the ratio of the voltage output from the power conversion circuit to the voltage output from the power source 11. As the duty ratio for the ON/OFF operation of the switching element decreases, the level of voltage output from the power conversion circuit may decrease. The vaporizer heater 191 may be heated based on the voltage output from the power conversion circuit.

The controller 12 may control the power supply circuit to supply power to the heater 18 using at least one of a pulse width modulation (PWM) scheme and a proportional-integral-differential (PID) scheme.

For example, the controller 12 may control the power supply circuit to supply a current pulse with a predetermined frequency and a duty ratio to the vaporizer heater 191 by using the PWM scheme. The controller 12 may control the power supplied to the vaporizer heater 191 by adjusting the frequency and duty ratio of the current pulse.

For example, the controller 12 may determine a target temperature, the target of the controlling, based on the temperature profile. The controller 12 may control the power supplied to the vaporizer heater 191 using the PID scheme, which is a feedback control scheme through the difference value between the temperature of the vaporizer heater 191 and the target temperature, the value obtained by integrating the difference value over time, and the value obtained by differentiating the difference value over time.

The controller 12 may prevent overheating of the vaporizer heater 191. For example, the controller 12 may control the operation of the power conversion circuit to stop supplying power to the vaporizer heater 191 based on the temperature of the vaporizer heater 191 exceeding a preset temperature limit. For example, the controller 12 may reduce the amount of power supplied to the vaporizer heater 191 by a predetermined proportion, based on the temperature of the vaporizer heater 191 exceeding the preset temperature limit. For example, the controller 12 may determine that the aerosol generating material accommodated in the vaporizer 19 is exhausted based on the temperature of the vaporizer heater 191 exceeding the temperature limit, and cut off the power supply to the vaporizer heater 191.

The controller 12 may control the charging and discharging of the power source 11. The controller 12 may verify the temperature of the power source 11 based on an output signal from the temperature sensor 131.

When a power line is connected to a battery terminal of the aerosol generating device 1, the controller 12 may verify whether the temperature of the power source 11 is greater than or equal to a first temperature limit which is the criterion for cutting off the charging of the power source 11. The controller 12 may control the power source 11 to be charged based on a preset charging current when the temperature of the power source 11 is less than the first temperature limit. The controller 12 may cut off the charging of the power source 11 when the temperature of the power source 11 is greater than or equal to the first temperature limit.

In a state in which the aerosol generating device 1 is powered ON, the controller 12 may verify whether the temperature of the power source 11 is greater than or equal to a second temperature limit which is the criterion for cutting off the discharging of the power source 11. The controller 12 may control the power stored in the power source 11 to be used when the temperature of the power source 11 is less than the second temperature limit. The controller 12 may stop using the power stored in the power source 11 when the temperature of the power source 11 is greater than or equal to the second temperature limit.

The controller 12 may calculate the remaining capacity for the power stored in the power source 11. For example, the controller 12 may calculate the remaining capacity of the power source 11 based on the voltage of the power source 11 and/or the value of current sensed.

The controller 12 may determine whether the aerosol generating article S is inserted into the insertion space through the insertion detection sensor 133. The controller 12 may determine that the aerosol generating article S is inserted based on an output signal from the insertion detection sensor 133. When it is determined that the aerosol generating article S is inserted into the insertion space, the controller 12 may supply power to the vaporizer heater 191. For example, the controller 12 may supply power to the vaporizer heater 191 based on the temperature profile stored in the memory 17.

The controller 12 may determine whether the aerosol generating article S is removed from the inner space. For example, the controller 12 may determine whether the aerosol generating article S is removed from the inner space through the insertion detection sensor 133. For example, the controller 12 may determine that the aerosol generating article S is removed from the inner space when the temperature of the heater 18 is greater than or equal to a temperature limit or when the gradient of the temperature change of the heater 18 is greater than or equal to a set gradient. When it is determined that the aerosol generating article S is removed from the inner space, the controller 12 may cut off the supply of power to the vaporizer heater 191.

The controller 12 may control a power supply time and/or a power supply amount for the vaporizer heater 191 according to a state of the aerosol generating article S sensed by the sensor 13. The controller 12 may verify a level range including the level of a signal of the capacitance sensor based on a lookup table. The controller 12 may determine the amount of moisture in the aerosol generating article S according to the verified level range.

When the aerosol generating article S is in an over-humidified state, the controller 12 may control the power supply time for the vaporizer heater 191 to increase a preheating time of the aerosol generating article S compared to being in a general state.

The controller 12 may determine whether the aerosol generating article S inserted into the insertion space is reused through the reuse detection sensor 134. For example, the controller 12 may compare a sensed value of a signal of the reuse detection sensor 134 with a first reference range including a first color, and when the sensed value falls within the first reference range, determine that the aerosol generating article S is unused. For example, the controller 12 may compare the sensed value of the signal of the reuse detection sensor 134 with a second reference range including a second color, and when the sensed value falls within the second reference range, determine that the aerosol generating article S is used. When it is determined that the aerosol generating article S is used, the controller 12 may cut off the supply of power to the vaporizer heater 191.

The controller 12 may determine whether the vaporizer 19 is coupled and/or decoupled, through the cartridge detection sensor 135. For example, the controller 12 may determine whether the vaporizer 19 is coupled and/or decoupled based on a sensed value of a signal of the cartridge detection sensor 135.

The controller 12 may determine whether the aerosol generating material in the vaporizer 19 is exhausted. For example, the controller 12 may preheat the vaporizer heater 191 by applying power, determine whether the temperature of the vaporizer heater 191 exceeds the temperature limit in a preheating period, and determine that the aerosol generating material in the vaporizer 19 is exhausted when the temperature of the vaporizer heater 191 exceeds the temperature limit. When it is determined that the aerosol generating material in the vaporizer 19 is exhausted, the controller 12 may cut off the supply of power to the vaporizer heater 191.

The controller 12 may determine the vaporizer 19 is usable. For example, the controller 12 may determine that the vaporizer 19 is unusable when the current number of puffs is greater than or equal to the maximum number of puffs set in the vaporizer 19 based on the data stored in the memory 17. For example, the controller 12 may determine that the vaporizer 19 is unusable when the total time for which the heater 24 is heated is greater than or equal to a preset maximum time or when the total amount of power supplied to the heater 24 is greater than or equal to a preset maximum amount of power.

The controller 12 may perform a determination about the inhalation of the user through the puff sensor 132. For example, the controller 12 may determine whether a puff occurs based on a sensed value of a signal of the puff sensor 132. For example, the controller 12 may determine the strength of the puff based on the sensed value of the signal of the puff sensor 132. When the number of puffs reaches a preset maximum number of puffs or when a puff is not detected for more than a preset time, the controller 12 may cut off the supply of power to the vaporizer heater 191.

The controller 12 may determine whether the cap is put on and/or taken off, through the cap detection sensor 136. For example, the controller 12 may determine whether the cap is put on and/or taken off based on a sensed value of a signal of the cap detection sensor 136.

The controller 12 may control the output unit 14 based on a result of sensing by the sensor 13. For example, when the number of puffs counted through the puff sensor 132 reaches the preset number, the controller 12 may inform the user that the aerosol generating device 1 is to be ended soon, through at least one of the display 141, the haptic portion 142, or the sound output unit 143. For example, the controller 12 may inform the user an absence of the aerosol generating article S through the output unit 14 based on the determination that the aerosol generating article S is absent from the inner space. For example, the controller 12 may inform the user through the output unit 14 based on the determination that the vaporizer 19 and/or the cap is not mounted. For example, the controller 12 may provide information on the temperature of the vaporizer heater 191 to the user through the output unit 14.

Based on the occurrence of a predetermined event, the controller 12 may store and update the history of the event that occurred in the memory 17. The event may include the detection of inserting the aerosol generating article S, the initiation of heating the aerosol generating article S, the detection of puffs, the end of puffs, the detection of overheating of the vaporizer heater 191, the detection of applying overvoltage to the vaporizer heater 191, the end of heating the aerosol generating article S, the operation of powering ON/OFF the aerosol generating device 1, initiation of charging the power source 11, the detection of overcharging of the power source 11, the end of charging the power source 11, or the like, performed by the aerosol generating device 1. The history of the event may include the date and time the event occurred, log data corresponding to the event, and the like. For example, if the predetermined event is the detection of inserting the aerosol generating article S, the log data corresponding to the event may include data on the sensed value of the insertion detection sensor 133. For example, if the predetermined event is the detection of overheating of the vaporizer heater 191, the log data corresponding to the event may include data on the temperature of the vaporizer heater 191, the voltage applied to the vaporizer heater 191, the current flowing in the vaporizer heater 191, and the like.

The controller 12 may form a communication link with an external device, such as a mobile terminal of the user. When authentication data is received from the external device via the communication link, the controller 12 may remove restrictions on the use of at least one function of the aerosol generating device 1. Here, the authentication data may include data indicating the completion of user authentication for the user corresponding to the external device. The user may perform user authentication through the external device. The external device may determine whether user data is valid based on the date of birth of the user, a unique number that identifies the user, and the like, and receive data on the authority to use the aerosol generating device 1 from an external server. The external device may transmit data indicating the completion of user authentication to the aerosol generating device 1 based on the data on the authority to use. In response to the completion of the user authentication, the controller 12 may remove restrictions on the use of at least one function of the aerosol generating device 1. For example, in response to the completion of the user authentication, the controller 12 may remove restrictions on the use of a heating function that supplies power to the vaporizer heater 191.

The controller 12 may transmit state data of the aerosol generating device 1 to the external device via the communication link with the external device. Based on the received state data, the external device may output the remaining capacity, the operation mode, and the like of the power source 11 of the aerosol generating device 1 through a display of the external device.

The external device may transmit a location search request to the aerosol generating device 1 based on an input that initiates a search for the location of the aerosol generating device 1. When the location search request is received from the external device, the controller 12 may control at least one of output devices to perform an operation corresponding to the location search based on the received location search request. For example, in response to the location search request, the haptic portion 142 may generate vibrations. For example, in response to the location search request, the display 141 may output an object corresponding to the location search and the end of the search.

When firmware data is received from the external device, the controller 12 may perform a firmware update. The external device may check the current version of the firmware for the aerosol generating device 1 and determine whether a new version of the firmware is present. When an input that requests a firmware download is received, the external device may receive a new version of firmware data and transmit the new version of firmware data to the aerosol generating device 1. When the new version of firmware data is received, the controller 12 may update the firmware of the aerosol generating device 1.

The controller 12 may transmit data on the sensed value of at least one sensor 13 through the communication unit 16 to an external server (not shown), receive a learning model generated by learning the sensed value through machine learning such as deep learning from the external server, and store the learning model. The controller 12 may perform an operation of determining an inhalation pattern of the user, an operation of generating a temperature profile, and the like using the learning model received from the external server. The controller 12 may store, in the memory 17, the sensed value data of at least one sensor 13 and the data used to train an artificial neural network (ANN). For example, the memory 17 may store a database for each component provided in the aerosol generating device 1, weights that form the structure of the ANN, and biases, for training the ANN. The controller 12 may generate at least one learning model that learns the data on the sensed value of at least one sensor 13, the inhalation pattern of the user, the temperature profile, and the like, stored in the memory 17, and is used to determine the inhalation pattern of the user and generate the temperature profile.

Referring to FIG. 4, the aerosol generating article S, according to an embodiment, May include a first filter segment S1, a medium segment S2, a second filter segment S3, and a wrapper S5.

In an embodiment, the aerosol generating article S may be wrapped with at least one wrapper S5. The wrapper S5 may have at least one hole through which external air is introduced or internal gas flows out. The wrapper S5 may include a material with high thermal conductivity.

For example, the first filter segment S1 may be wrapped with a first wrapper S51, the medium segment S2 may be wrapped with a second wrapper S52, and the second filter segment S3 may be wrapped with a third wrapper S53. In addition, the aerosol generating article S may be entirely wrapped again with a fifth wrapper S55.

In an embodiment, the first wrapper S51, the second wrapper S52, and the third wrapper S53 may be formed with porous wrapping paper. For example, the porosity of each of the first wrapper S51, the second wrapper S52, and the third wrapper S53 may be about 35000 CU, but is not limited thereto. In addition, the thickness of each of the first wrapper S51, the second wrapper S52, and the third wrapper S53 may be in the range of 70 μm to 80 μm. In addition, the basis weight of each of the first wrapper S51, the second wrapper S52, and the third wrapper S53 may be in the range of 20 g/m² to 25 g/m².

In an embodiment, the fifth wrapper S55 may be formed of sterile paper (e.g., MFW). For example, the basis weight of the fifth wrapper S55 may be in the range of 57 g/m² to 63 g/m². Also, the thickness of the third wrapper S53 may be in the range of 70 μm to 80 μm.

In an embodiment, the first filter segment S1 may include a cellulose acetate filter. In addition, the first filter segment S1 may include a paper filter and a porous molding. For example, the length of the first filter segment S1 may be about 4 to 15 mm, but examples are not limited thereto. In addition, the first filter segment S1 may be colored and flavored.

In an embodiment, the medium segment S2 may be filled with a medium. For example, the medium segment S2 may include a cavity, and the cavity may be filled with the medium. As another example, the medium segment S2 may include a cellulose acetate filter or a paper filter and may be filled with the medium as the medium is inserted into the cellulose acetate filter or the paper filter.

For example, the medium used to fill the medium segment S2 may include at least one component of granular tobacco (tobacco granules), reconstituted tobacco, or cut tobacco leaves. For example, a desirable length of the medium segment S2 may be adopted from a range of 6 mm to 18 mm, but examples are not limited thereto.

Generally, tobacco granules have a significantly lower content of moisture and/or aerosol former than other types of tobacco materials (e.g., cut tobacco leaves, reconstituted tobacco, and the like) and thus may greatly reduce the generation of visible smoke, which may facilitate the implementation of a smokeless function of the aerosol generating device 11. However, the tobacco granules may vary in diameter, density, filling rate, composition ratio of constituent materials, heating temperature, and the like, etc. depending on the embodiment. The diameter of tobacco granules may be about 0.3 mm to 1.2 mm. Within this numerical range, the proper hardness and ease of manufacture of the tobacco granules may be guaranteed, and the probability of vortex airstream in the cavity may be increased.

Further, the medium segment S2 may include other additives such as a flavoring agent, a humectant, and/or organic acid. In addition, the medium segment S2 may include a flavoring liquid such as menthol or a moisturizing agent that is added as being sprayed onto the medium segment S2.

In an embodiment, the medium used to fill the medium segment S2 may be pH-treated. For example, the medium may be pH-treated by a pH control agent to have basicity. The pH control agent may be basic and may include, for example, at least one of potassium carbonate (K₂CO₃), sodium bicarbonate (NaHCO₃), and calcium oxide (CaO). However, the material included in the pH control agent is not limited to the above examples, and a material that generates less negative odor during smoking may be used. A basic pH control agent may increase the pH of the medium included in the medium segment S2. Compared to a medium not treated with a basic pH control agent, a medium pH-treated with a basic pH control agent may increase the amount of nicotine released therefrom. That is, a medium pH-treated with a basic pH control agent may achieve a sufficient nicotine yield from the medium segment S2 even at a low temperature.

In an embodiment, the medium segment S2 may include slurry or paper-like reconstituted tobacco sheets having a pH adjusted to a range of 8.0 to 9.5 or may be filled with tobacco granules having a pH adjusted to a range of 8.0 to 9.5. The medium may include nicotine, and when the medium is pH-treated with a basic pH control agent, free nicotine (e.g., nicotine gas) may be transferred from the medium even under non-heating conditions or relatively low-temperature conditions. That is, by adjusting the pH of the medium in the medium segment S2 to a range of 7.0 to 9.5, volatile free nicotine may be transferred under non-heating conditions (or low-temperature conditions), and a sufficient level of intensity of smoking taste may be implemented.

In an embodiment, the second filter segment S3 may include a cellulose acetate filter. In addition, the second filter segment S3 may include at least one flavor capsule. For example, the second filter segment S3 may be a cellulose acetate filter into which at least one flavor capsule is inserted. In addition, the second filter segment S3 may include a cellulose acetate filter mixed with a flavored substance.

In an embodiment, nicotine may be adsorbed into at least any one of the first filter segment S1 and the second filter segment S3. As the medium segment S2 is pH-treated to the range of 7.0 to 9.5, nicotine in the medium segment S2 may vigorously become free nicotine even under non-heating conditions and be transferred to the first filter segment S1 or the second filter segment S3, and the nicotine transferred from the medium segment S2 may be adsorbed into at least one of the first filter segment S1 and the second filter segment S3. As the first filter segment S1 or the second filter segment S3 also includes nicotine along with the medium segment S2, the aerosol generating article S may be used even without preheating the aerosol generating device 1. This may not only increase the convenience of the user but also implement a transfer of sufficient nicotine even under non-heating (or low-temperature heating) conditions, thereby providing smoking taste satisfaction accordingly.

In an embodiment, a cooling segment (not shown) may be included between the medium segment S2 and the second filter segment S3. The cooling segment may cool an aerosol that passes through the medium segment S2. For example, the cooling segment 112 may be made of cellulose acetate and may be a tubular structure including a hollow therein. For example, the cooling segment 112 may be manufactured by adding a plasticizer (e.g., triacetin) to cellulose acetate tow. For example, the cooling segment 112 may be made of paper and may be a tubular structure including a hollow therein. A desirable diameter of the hollow included in the cooling segment 112 may be adopted from a range of 4 mm to 8 mm, but examples are not limited thereto.

FIG. 5 is an exploded view illustrating a housing part 10-1 included in the inner space 104 of the housing 10.

Referring to FIG. 5, the first sensor 13-1 and the second sensor 13-2 may be arranged along the longitudinal direction (e.g., a +/−X direction in FIG. 5) of the inner space 104.

In an embodiment, the first sensor 13-1 and the second sensor 13-2 may be arranged sequentially along the direction (e.g., the −X direction in FIG. 5) from the first surface 101 to the inner space end surface 1042.

At least a portion of the first sensor 13-1 is exposed to the inner space 104 and may detect the state of the aerosol generating article S inserted into the inner space 104. At least a portion of the second sensor 13-2 is exposed to the inner space 104 and may detect the state of the aerosol generating article S inserted into the inner space 104. For example, at least a portion of the first sensor 13-1 and/or the second sensor 13-2 may be exposed from the inner space side surface 1043. For another example, the first sensor 13-1 and/or the second sensor 13-2 are accommodated inside the housing part 10-1 and may detect the state of the aerosol generating article S without being exposed to the inner space 104. Yet another example, at least a portion of the first sensor 13-1 may be disposed at a position exposed from the inner space side surface 1043, and at least a portion of the second sensor 13-2 may be disposed at a position exposed from the inner space end surface 1042.

In an embodiment, the first sensor 13-1 may include a first capacitance sensor, and the second sensor 13-2 may include a second capacitance sensor. The first capacitive sensor and/or the second capacitive sensor may include a conductor. The conductor may be disposed adjacent to the inner space side surface 1043. The first capacitive sensor and/or the second capacitive sensor may output a signal corresponding to the capacitance of a segment (compartment) of the aerosol generating article S that is adjacent thereto. For example, if the moisture content of each segment of the aerosol generating article S is different, electromagnetic characteristics around the conductor may vary, and the first capacitive sensor and the second capacitive sensor may indicate capacitive values respectively corresponding to segments.

In an embodiment, the first sensor 13-1 may include a first inductive sensor, and the second sensor 13-2 may include a second inductive sensor. The first inductive sensor and/or the second inductive sensor may include at least one coil. The coil may be disposed adjacent to the inner space side surface 1043. For example, if the magnetic field changes around the coil through which an electric current flows, the properties of the current flowing through the coil may change according to Faraday's law of electromagnetic induction. The first inductive sensor and/or the second inductive sensor may output a signal corresponding to the properties of the current flowing through the coil. For example, if the moisture content of each segment of the aerosol generating article S is different, the first inductive sensor and the second inductive sensor may indicate signal values respectively corresponding to the segments.

A signal measured by the first sensor 13-1 and/or the second sensor 13-2 may be transmitted to a controller (e.g., the controller 12 of FIG. 1 or 2) via a connector 13-3.

FIG. 6 illustrates the aerosol generating article S inserted into the inner space 104 in the housing part 10-1 of FIG. 5.

Referring to FIG. 6, in an embodiment, when the aerosol generating article S is fully inserted into the inner space 104, the first sensor 13-1 may be disposed at a position corresponding to the medium segment S2 of the aerosol generating article S. For example, the first sensor 13-1 may be disposed at a position (e.g., along a YZ plane in FIG. 6) horizontally away from the medium segment S2.

In an embodiment, when the aerosol generating article S is fully inserted into the inner space 104, the second sensor 13-2 may be disposed at a position corresponding to the first filter segment S1 of the aerosol generating article S. For example, the second sensor 13-2 may be disposed at a position (e.g., along the YZ plane in FIG. 6) horizontally away from the first filter segment S1.

When the first sensor 13-1 includes a first capacitive sensor, and the second sensor 13-2 includes a second capacitive sensor, the first sensor 13-1 may detect the degree of wetness (over-wetting) of the medium segment S2, and the second sensor 13-2 may detect the degree of wetness (over-wetting) of the first filter segment S1.

In an embodiment, when the first sensor 13-1 includes a capacitive sensor and the second sensor 13-2 includes a capacitive sensor, the area of the first sensor 13-1 exposed to the inner space side surface 1043 may be the same as the area of the second sensor 13-2 exposed to the inner space side surface 1043. By having the exposed area of the first sensor 13-1 and the exposed area of the second sensor 13-2 the same, interference between the two sensors may be minimized.

In this case, the first sensor 13-1 may be disposed adjacent to the first surface 101 and the second sensor 13-2 may be disposed adjacent to the inner space end surface 1042 such that the influence between the first sensor 13-1 and the second sensor 13-2 is minimized. For example, considering the set size of the aerosol generating device 1, a distance between the first sensor 13-1 and the second sensor 13-2 may be maximized. For example, the second sensor 13-2 may be disposed at the innermost part of the inner space 104. Likewise, the first sensor 13-1 may be disposed the most adjacent to the first surface 101, but the position of a proximity sensor may allow the first sensor 13-1 to be disposed below the proximity sensor from the first surface 101.

In an embodiment, the controller 12 may determine whether the aerosol generating article S is over-humidified, based on first information (e.g., a variance in the capacitance of the medium segment S2) received from the first sensor 13-1. The controller 12 may determine whether the aerosol generating article S is reused, based on second information (e.g., a variance in the capacitance of the first filter segment S1) received from the second sensor 13-2.

In an embodiment, when the first sensor 13-1 includes the first capacitive sensor, and the second sensor 13-2 includes the second capacitive sensor, electric fields of different frequency bands may be applied to the first sensor 13-1 and the second sensor 13-2.

For example, an electric field of a first frequency band sensitive to moisture detection may be applied to the first sensor 13-1. For example, an electric field of a second frequency band sensitive to detection of an aerosol generating material (e.g., glycerin or propylene glycol) may be applied to the second sensor 13-2.

Depending on the frequency of an electric field applied to a capacitive sensor, a capacitive value may be measured differently. If an electric field of the same frequency is applied to the first sensor 13-1 and the second sensor 13-2, there may be an overlapping portion between a range between maximum and minimum capacitive values measured for the aerosol generating article S in an over-humidified state and a range between maximum and minimum capacitive values measured for the aerosol generating article S in a reused state. In this case, it may not be clear whether the aerosol generating article S is in an over-humidified state or a reused state.

To prevent this, the controller 12 may apply an electric field of the first frequency band sensitive to moisture detection to the first sensor 13-1 and an electric field of the second frequency band sensitive to the detection of an aerosol generating material to the second sensor 13-2 such that a range between maximum and minimum capacitive values measured by the first sensor 13-1 may not overlap a range between maximum and minimum capacitive values measured by the second sensor 13-2.

For example, in an environment, such as the rainy season, with high humidity, the aerosol generating article S may be in an over-humidified state. The wetness degree of the aerosol generating article S may change due to over-humidity. When the wetness degree of the aerosol generating article S changes, a dielectric constant may also change. Thus, the measured capacitive value may vary. In an over-humidification state, the first filter segment S1, the medium segment S2, and the second filter segment S3 of the aerosol generating article S may be all wet with moisture and may exhibit a capacitive value that converges to a corresponding humidity.

For example, the aerosol generated by the vaporizer (e.g., the vaporizer 19 of FIG. 1 or 2) may enter the first filter segment S1 of the aerosol generating article S and may travel through the medium segment S2 to the second filter segment S3. As the aerosol moves in a downstream direction (e.g., in a +X direction of FIG. 6) of the aerosol generating article S, the upstream of the aerosol generating article S may be wet more than the downstream by the aerosol. In the used aerosol generating article S, the first filter segment S1, which is the upstream of the aerosol generating article S, may be wet more by an aerosol generating material (e.g., glycerin or propylene glycol) than the medium segment S2, which is the downstream of the aerosol generating article S.

Meanwhile, the controller 12 may apply an electric field to the first sensor 13-1, and, after stopping the application of the electric field to the first sensor 13-1, may sequentially apply an electric field to the second sensor 13-2. When an electric field is applied to the first sensor 13-1 and the second sensor 13-2 at the same time, values measured from the first sensor 13-1 and the second sensor 13-2 may be influenced by each other. When an electric field is applied to the first sensor 13-1 and the second sensor 13-2 with a time difference, interference between the first sensor 13-1 and the second sensor 13-2 may be prevented.

The controller 12 may determine that the aerosol generating article S is in an over-humidified state if a capacitance variance between a first timepoint (before the aerosol generating article S is inserted into the inner space 104) and a second timepoint (after the aerosol generating article S is inserted into the inner space 104) measured by the first sensor 13-1 is greater than a first set value. The first set value may be the maximum value of a capacitance variance in the aerosol generating article S in a normal state. Here, the normal state may be defined as a non-over-humidified state rather than an over-humidified state.

When the aerosol generating article S is determined to be in an over-humidified state, the controller 12 may determine that the aerosol generating article S is in an over-humidified reused state if a capacitance variance between the first timepoint and the second timepoint measured by the second sensor 13-2 is greater than a second set value. The second set value may be the maximum value of a capacitance variance in the aerosol generating article S in an over-humidified unused state.

When the aerosol generating article S is determined to be in a normal (non-over-humidified state), the controller 12 may determine that the aerosol generating article S is in a normal reused state if the capacitance variance between the first timepoint and the second timepoint measured by the second sensor 13-2 is greater than a third set value. The third set value may be the maximum value of a capacitance variance in the aerosol generating article S in a normal unused state.

Table 1 shows an example of how the controller 12 of the aerosol generating device 1, according to an embodiment, determines the state of the aerosol generating article S.

TABLE 1

| | Case1 | Case2 | Case3 | Case4 |
|---|---|---|---|---|
| Top flag | 0 | 0 | 1 | 1 |
| Bottom flag | 0 | 1 | 0 | 1 |
| State | Normal | Normal | Over- | Over- |
| | unused | reused | humidified | humidified |
| | | | unused | reused |
| Process | Possible | Impossible | Possible | Impossible |
| | to be | to be | to be | to be |
| | heated | heated | heated | heated |

Referring to Table 1, a top flag indicates a value according to a capacitance variance measured by the first sensor 13-1, and a bottom flag indicates a value according to a capacitance variance measured by the second sensor 13-2.

The controller 12 may set the top flag to 1 when the capacitance variance measured by the first sensor 13-1 is greater than the first set value. The controller 12 may set the top flag to 0 when the capacitance variance measured by the first sensor 13-1 is less than the first set value. Here, top flag 1 indicates an over-humidification state, and top flag 0 indicates a normal (non-over-humidified) state.

Then, in the state of top flag 1, the controller 12 may set the bottom flag to 1 when the capacitance variance measured by the second sensor 13-2 is greater than the second set value. Then, in the state of top flag 0, the controller 12 may set the bottom flag to 1 when the capacitance variance measured by the second sensor 13-2 is greater than the third set value. Here, bottom flag 1 indicates a reused state.

In the state (case 1) of top flag 0 and bottom flag 0, the controller 12 may determine that the aerosol generating article S is a normal unused state. In this case, the controller 12 may operate the vaporizer heater 191.

In the state (case 2) of top flag 0 and bottom flag 1, the controller 12 may determine that the aerosol generating article S is a normal reused state. In this case, the controller 12 may not operate the vaporizer heater 191.

In the state (case 3) of top flag 1 and bottom flag 0, the controller 12 may determine that the aerosol generating article S is an over-humidified unused state. In this case, the controller 12 may operate the vaporizer heater 191.

In the state (case 4) of top flag 1 and bottom flag 1, the controller 12 may determine that the aerosol generating article S is an over-humidified reused state. In this case, the controller 12 may not operate the vaporizer heater 191.

Referring to FIG. 7, a method of determining a state of the aerosol generating article S, according to an embodiment, may include operation 1001 of providing the aerosol generating article S, operation 1002 of measuring a capacitance variance of the medium segment S2 of the aerosol generating article S by the first sensor 13-1 including a first capacitive sensor, operation 1003 of measuring a capacitance variance of the first filter segment S1 by the second sensor 13-2 including a second capacitive sensor, and operation 1004 of determining whether the aerosol generating article S is reused based on the capacitance variances.

In operation 1002 of measuring a capacitance variance of the medium segment S2 of the aerosol generating article S by the first sensor 13-1 including a first capacitive sensor, an electric field of a first frequency band sensitive to moisture detection may be applied to the first sensor 13-1.

In operation 1003 of measuring a capacitance variance of the first filter segment S1 by the second sensor 13-2 including a second capacitive sensor, an electric field of a second frequency band sensitive to the detection of an aerosol generating material may be applied to the second sensor 13-2.
operation 1004 of determining whether the aerosol generating article S is reused based on the capacitance variances may further include operation of determining that the aerosol generating article S is in an over-humidified reused state when the capacitance variance measured by the first sensor 13-1 is greater than a first set value and the capacitance variance measured by the second sensor 13-2 is greater than a second set value.
operation 1004 of determining whether the aerosol generating article S is reused based on the capacitance variances may further include operation of determining that the aerosol generating article S is in a normal reused state when the capacitance variance measured by the first sensor 13-1 is less than the first set value and the capacitance variance measured by the second sensor 13-2 is greater than a third set value.

FIG. 8 is an exploded perspective view illustrating the housing part 10-1 included in the inner space 104 of the housing 10, and, in the description provided with reference to FIG. 8, repeated descriptions of components described with reference to FIG. 5 are omitted for simplicity.

Referring to FIG. 8, in an embodiment, when the first sensor 13-1 includes a capacitive sensor and a second sensor 13-22 includes a capacitive sensor, the area of the second sensor 13-22 exposed to the inner space side surface 1043 may be the greater than the area of the first sensor 13-1 exposed to the inner space side surface 1043.

Capacitance may be inversely proportional to a distance between spaces including dielectrics and proportional to the cross-sectional area of the dielectrics. Accordingly, when the aerosol generating article S is inserted into the inner space 104, and the area of the capacitive sensor exposed to the inner space side surface 1043 is great, a large amount of charge may be received.

Since the exposed area of the second sensor 13-22 is greater than that of the first sensor 13-1, the degree of wetness of the first filter segment S2, which is wet more by an aerosol, may be measured more precisely.

Here, a width W2 of the second sensor 13-22 along the circumferential direction of the inner space side surface 1043 may be greater than a width W1 of the first sensor 13-1 along the circumferential direction of the inner space side surface 1043. A great exposed area of the second sensor 13-22 may enable the second sensor 13-22 to receive a magnetic field from the medium segment S2 when a portion of the second sensor 13-22 approaches the first sensor 13-1. In this case, the exposed area of the second sensor 13-22 may be increased by increasing the width W2 without increasing a longitudinal length (e.g., a +/−X direction in FIG. 7) of the second sensor 13-22. This may also help to separate the first sensor 13-1 from the second sensor 13-22 as much as possible.

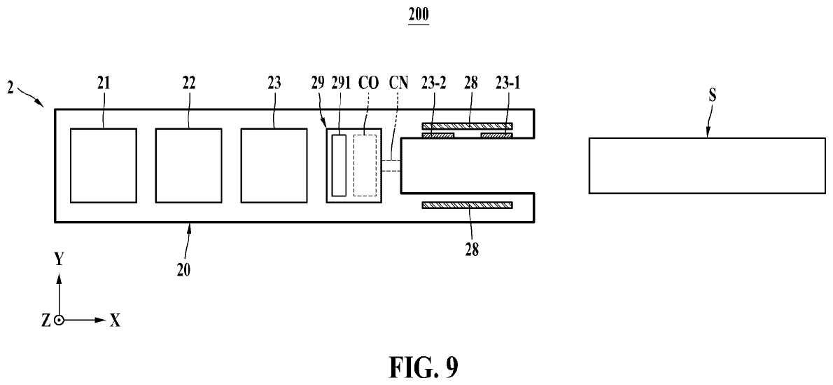

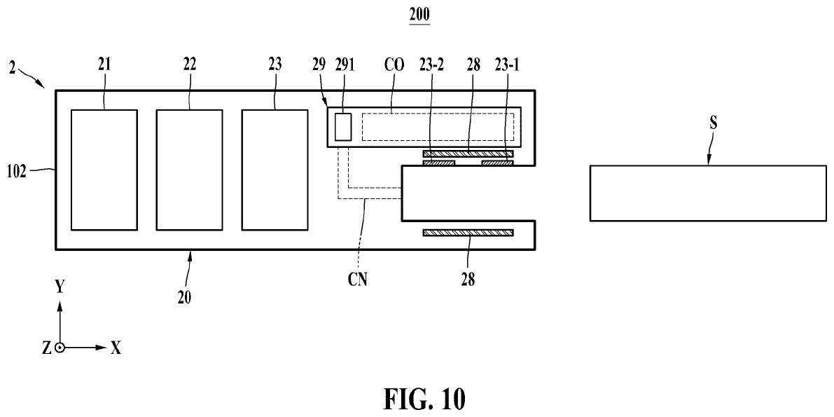

FIGS. 9 and 10 illustrate an aerosol generating system 200, according to an embodiment.

Referring to FIGS. 9 and 10, the aerosol generating system 200 may include an aerosol generating device 2 and an aerosol generating article S. The aerosol generating device 2 may include at least one of a power source 21, a controller 22, a sensor 23, a vaporizer 29, and a heater 28. At least one of the power source 21, the controller 22, the sensor 23, and the heater 28 may be disposed inside a housing 20 of the aerosol generating device 2. The housing 20 may provide a single side opening space into which the aerosol generating article S is inserted.

The heater 28 may heat the aerosol generating article S. The heater 28 may be elongated upward around the space into which the aerosol generating article S is inserted. For example, the heater 28 may be in a tube form including a hollow therein. The heater 28 may be disposed around the inner space. The heater 28 may be disposed to surround at least a portion of the inner space. The heater 28 may heat the inner space or the aerosol generating article S inserted into the inner space. The heater 28 may include an electrically resistive heater and/or an induction heater.

For example, the heater 28 may be a resistive heater. For example, the heater 28 may include an electrically conductive track, and the heater 28 may be heated with a current flowing through the electrically conductive track. The heater 28 may be electrically connected to the power source 21. The heater 28 may directly generate heat by receiving a current from the power source 21.

For example, the aerosol generating device 2 may include an induction coil surrounding the heater 28. The induction coil may heat the heater 28. As a susceptor, the heater 28 may be heated up by a magnetic field generated by an AC flowing through the induction coil. The magnetic field may pass through the heater 28 and generate an eddy current in the heater 28. A current may generate heat in the heater 28.

In addition, the susceptor may be included inside the aerosol generating article S. The susceptor inside the aerosol generating article S may be heated by the magnetic field generated by the AC flowing through the induction coil.

The vaporizer 29 may contain an aerosol generating material having any one of a liquid state, a solid state, a gaseous state, or a gel state. The aerosol generating material may include a liquid composition. The liquid composition may be, for example, a liquid including a tobacco-containing material that includes a volatile tobacco flavor component or may be a liquid including a non-tobacco material. The vaporizer 29 may be formed integrally with the housing 10 or detachably coupled to the housing 20.

For example, referring to FIG. 9, the vaporizer 29 may be formed integrally with the housing 20 and may communicate with the inner space through an airflow channel CN.

For example, referring to FIG. 10, a space may be formed on one side of the housing 20, at least a portion of the vaporizer 29 is inserted into the space formed on one side of the housing 20, and the vaporizer 29 may be mounted on the housing 20. The airflow channel CN may be defined by a portion of the vaporizer 29 and/or a portion of the housing 20, and the vaporizer 29 may communicate with the inner space through the airflow channel CN.

The housing 20 may be formed in a structure in which the outside air may be introduced into the interior of the housing 20 while the vaporizer 29 is inserted thereinto. In this case, the external air entering the housing 20 may pass through the vaporizer 29 and flow into the oral cavity of a user.

The vaporizer 29 may include a storage CO, which contains an aerosol generating material, and/or a heater 291 for heating the aerosol generating material in the storage CO. A liquid transfer means impregnated with (containing) the aerosol generating material may be disposed inside the storage CO. Here, the liquid transfer means may include a wick, such as a cotton fiber, a ceramic fiber, a glass fiber, or a porous ceramic, and the like. An electrically conductive track of the heater 291 may be formed having a coil-type structure that is wound around the liquid transfer means or a structure that is in contact with one side of the liquid transfer means. The heater 291 may be referred to as a vaporizer heater 291.

The vaporizer 29 may generate an aerosol. The aerosol may be generated as the liquid transfer means is heated by the vaporizer heater 291. The aerosol generating article S may be heated by the heater 291, thereby generating the aerosol. While the aerosol generated by the vaporizer heater 291 passes through the aerosol generating article S, a tobacco material may be added to the aerosol. The aerosol with the tobacco material may be inhaled into the oral cavity of the user through one end of the aerosol generating article S.

The aerosol generating device 2 may include a cap (not shown). The cap may be detachably coupled to the housing 20 to cover at least a portion of the vaporizer 29 coupled to the housing 20. The aerosol generating article S may be inserted into the housing 20 by passing through the cap.

The power source 21 may supply power to operate the components of the aerosol generating device 2. The power source 21 may be referred to as the battery. The power source 21 may supply power to at least one of the controller 22, the sensor 23, the vaporizer heater 291, and the heater 28.

The controller 22 may control the overall operation of the aerosol generating device 2. The controller 22 may be mounted on a PCB. The controller 22 may control the operation of at least one of the power source 21, the sensor 23, the vaporizer 29, and the heater 28. The controller 22 may control the operation of the display, a motor, and the like installed in the aerosol generating device 2. The controller 22 may verify a state of each of the components of the aerosol generating device 2 to determine whether the aerosol generating device 2 is in an operable state.

The controller 22 may analyze a sensing result obtained by the sensing of the sensor 23 and control processes to be performed thereafter. For example, the controller 22 May control power to be supplied to the vaporizer heater 291 and/or the heater 28 to start or end an operation of the vaporizer heater 291 and/or the heater 28 based on the sensing result obtained by the sensor 23. For example, the controller 22 may control an amount of power to be supplied to the vaporizer heater 291 and a time for which the power is to be supplied, such that the vaporizer heater 291 may be heated up to a predetermined temperature or maintained at a desired temperature, based on the sensing result obtained by the sensor 23.

The sensor 23 may include at least one of a temperature sensor, a puff sensor, an insertion detection sensor, a color sensor, a cartridge detection sensor, or a cap detection sensor. For example, the sensor 23 may sense at least one of the temperature of the vaporizer heater 291 and/or the heater 28, the temperature of the power source 21, or the temperature inside and outside the housing 20. For example, the sensor 23 may sense a puff of the user. For example, the sensor 23 may sense whether the aerosol generating article S is inserted into the inner space. For example, the sensor 23 may sense whether the vaporizer 29 is mounted. For example, the sensor 23 may sense whether the cap is mounted.

A first sensor 23-1 and a second sensor 23-2 may be arranged along a longitudinal direction (e.g., along a −X direction in FIGS. 8 and 9) of the inner space.

The controller 22 may receive first information sensed by the first sensor 23-1 and second information sensed by the second sensor 23-2 and may determine the state of the aerosol generating article S based on the first information and the second information. The functions of the first sensor 23-1 and the second sensor 23-2 are the same as or similar to those of the first sensor 13-1 and the second sensor 13-2, and thus, the detailed descriptions thereof are omitted for simplicity.

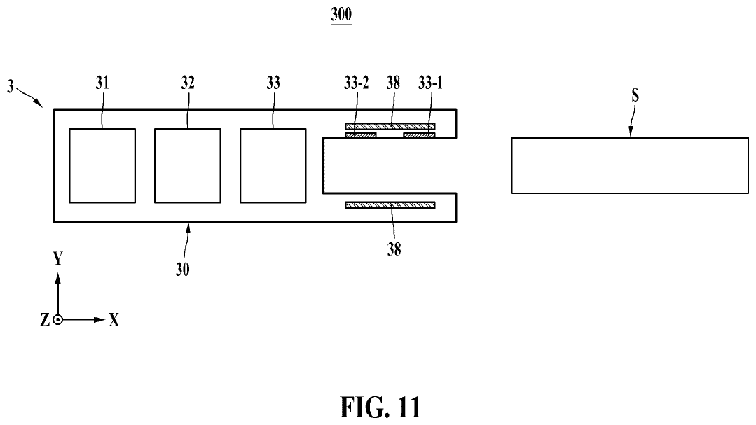

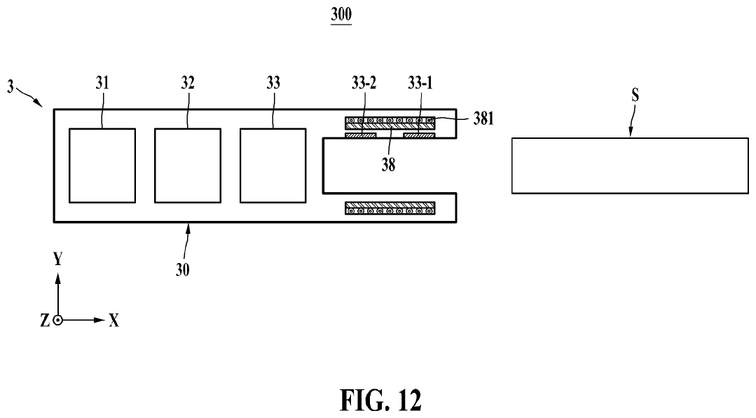

FIGS. 11 and 12 illustrate an aerosol generating device 300, according to embodiments of the present disclosure. The aerosol generating system 300 may include an aerosol generating device 3 and an aerosol generating article S.

Referring to FIG. 11, the aerosol generating device 3 may include at least one of a power source 31, a controller 32, a sensor 33, and a heater 38. At least one of the power source 31, the controller 32, the sensor 33, and the heater 38 may be disposed inside a housing 30 of the aerosol generating device 3. The housing 30 may provide an upward-opening space into which the aerosol generating article S is inserted. The upward-opening space may be referred to as an inner space.

The heater 38 may heat the aerosol generating article S. The heater 38 may be elongated upward around the space into which the aerosol generating article S is inserted. For example, the heater 38 may be in a tube form including a hollow therein. The heater 38 may be disposed around the inner space. The heater 38 may be disposed to surround at least a portion of the inner space. The heater 38 may heat the inner space or the aerosol generating article S inserted into the inner space. The heater 38 may include an electrically resistive heater and/or an induction heater.

For example, referring to FIG. 11, the heater 38 may be a resistive heater. For example, the heater 38 may include an electrically conductive track, and the heater 38 may be heated with a current flowing through the electrically conductive track. The heater 38 may be electrically connected to the power source 31. The heater 38 may directly generate heat by receiving a current from the power source 31. As a hollow heater, the heater 38 may be disposed to surround at least a portion of the aerosol generating article S inserted into the insertion space to heat an outer portion of the aerosol generating article S. Alternatively, as a needle-shaped heater, a rod-shaped heater, a tubular heater, or the like, the heater 38 may be inserted into the aerosol generating article S inserted into the insertion space to heat the inside of the aerosol generating article S.

For example, referring to FIG. 12, the aerosol generating device 3 may include an induction coil 381 surrounding the heater 38. The induction coil 381 may heat the heater 38. As a susceptor, the heater 38 may be heated up by a magnetic field generated by an AC flowing through the induction coil 381. The magnetic field may pass through the heater 38 and generate an eddy current in the heater 38. A current may generate heat in the heater 38.

In addition, the susceptor may be included inside the aerosol generating article S. The susceptor inside the aerosol generating article S may be heated by the magnetic field generated by the AC flowing through the induction coil 381.

The power source 31 may supply power to operate the components of the aerosol generating device 3. The power source 31 may be referred to as the battery. The power source 31 may supply power to at least one of the controller 32, the sensor 33, or the heater 38. When the aerosol generating device 3 includes the induction coil 381, the power source 31 may supply power to the induction coil 381.

The controller 32 may control the overall operation of the aerosol generating device 3. The controller 32 may be mounted on a PCB. The controller 32 may control the operation of at least one of the power source 31 or the sensor 33. The controller 32 may control the operation of the induction coil 381. The controller 32 may control the operation of the display, a motor, and the like installed in the aerosol generating device 3. The controller 32 may verify a state of each of the components of the aerosol generating device 3 to determine whether the aerosol generating device 3 is in an operable state.

The controller 32 may analyze a sensing result obtained by the sensing of the sensor 33 and control processes to be performed thereafter. For example, based on the sensing result obtained by the sensor 33, the controller 32 may control the power supplied to the heater 38 to initiate or terminate the operation of the heater 38. For example, based on the sensing result obtained by the sensor 33, the controller 32 may control the amount of power supplied to the heater 38 and a time for which the power is supplied, such that the heater 38 may be heated to a predetermined temperature or maintained at an appropriate temperature.

The sensor 33 may include at least one of a temperature sensor, a puff sensor, or an insertion detection sensor. For example, the sensor 33 may sense at least one of the temperature of the heater 38, the temperature of the power source 31, or the temperature inside and outside the housing 30. For example, the sensor 33 may sense a puff of the user. For example, the sensor 33 may sense whether the aerosol generating article S is inserted into the insertion space.

A first sensor 33-1 and a second sensor 33-2 may be arranged along a longitudinal direction (e.g., along a −X direction in FIG. 10 or 11) of the inner space.

The controller 32 may receive first information sensed by the first sensor 33-1 and second information sensed by the second sensor 33-2 and may determine the state of the aerosol generating article S based on the first information and the second information. The functions of the first sensor 33-1 and the second sensor 33-2 are the same as or similar to those of the first sensor 13-1 and the second sensor 13-2, and thus, the detailed descriptions thereof are omitted for simplicity.

Meanwhile, the aerosol generating article S may include a first filter segment, a medium segment, a cooling segment, and a second filter segment. The first filter segment may include an atomization segment. For example, the atomization segment may be filled with a moisturizing agent, and the moisturizing agent may include, for example, at least one of glycerin, propylene glycol, ethylene glycol, dipropylene glycol, diethylene glycol, triethylene glycol, tetraethylene glycol, and oleyl alcohol, but is not limited thereto. In the case where the first filter segment includes an atomization segment, the aerosol generating device 3 may not be provided with a separate vaporizer. Instead, a heater may be disposed around and/or in the first filter segment including the atomization segment.

The aerosol generating device 1, 2, or 3, and the aerosol generating system 100, 200, or 300 including the same, according to an embodiment, may effectively determine whether the aerosol generating article S is reused. In addition, whether the aerosol generating article S is reused may be determined accurately even under over-humidified conditions, and whether the aerosol generating article S is in an over-humidified state may be determined effectively. In addition, the aerosol generating device 1, 2, or 3, according to one embodiment, may provide a user with optimal smoking satisfaction by using the state information of the aerosol generating article S.

According to an embodiment, the aerosol generating device 1 includes the housing 10 including the first surface 101, the second surface 102 opposite to the first surface 101, and the side surface 103 between the first surface 101 and the second surface 102, in which the inner space 104 into which the aerosol generating article S is inserted is formed on the first surface 101, the first sensor 13-1 disposed adjacent to the inner space 104, the second sensor 13-2 disposed adjacent to the inner space 104 at a position different from that of the first sensor 13-1, and the controller 12 that is accommodated by the housing 10 and includes at least one processor, in which the controller 12 is configured to determine whether the aerosol generating article S is over-humidified based on first information received from the first sensor 13-1 and determine whether the aerosol generating article S is reused based on second information received from the second sensor 13-2.

In an embodiment, electric fields of different frequency bands may be applied to the first sensor 13-1 and the second sensor 13-2.

An electric field of a first frequency band that is sensitive to moisture detection may be applied to the first sensor 13-1.

An electric field of a second frequency band sensitive to the detection of an aerosol generating material may be applied to the second sensor 13-2.

In an embodiment, the controller 12 may apply an electric field to the first sensor 13-1, and, after stopping the application of the electric field to the first sensor 13-1, may sequentially apply an electric field to the second sensor 13-2.

In an embodiment, the inner space 104 may include the inner space end surface 1042 positioned between the first surface 101 and the second surface 102 and the inner space side surface 1043 extending from an edge of the inner space end surface 1042 to the first surface 101, and the first sensor 13-1 and the second sensor 13-2 may be arranged sequentially along a direction from the first surface 101 toward the inner space end surface 1042.

The first sensor 13-1 may include a first capacitive sensor, and the second sensor 13-2 may include a second capacitive sensor.

The controller 12 may determine that the aerosol generating article S is in an over-humidified state when a capacitance variance measured by the first capacitive sensor is greater than a first set value.

When the aerosol generating article S is determined to be in an over-humidified state, the controller 12 may determine that the aerosol generating article S is in an over-humidified reused state if a capacitance variance measured by the second sensor 13-2 is greater than a second set value.

When the aerosol generating article S is determined to be in a non-over-humidified state, the controller 12 may determine that the aerosol generating article S is in a normal reused state if a capacitance variance measured by the second sensor 13-2 is greater than a third set value.

According to an embodiment, a method of determining a state of the aerosol generating article may include operation 1001 of providing the aerosol generating article including a first filter segment, a medium segment that is disposed in the downstream of the first filter segment and configured to accommodate a medium, and a second filter segment that is disposed in the downstream of the medium segment, operation 1002 of measuring a capacitance variance of the medium segment of the aerosol generating article by a first capacitive sensor, operation 1003 of measuring a capacitance variance of the first filter segment by a second capacitive sensor, and operation 1004 of determining whether the aerosol generating article is reused based on the capacitance variances.

An electric field of a first frequency band sensitive to moisture detection may be applied to the first capacitive sensor.

An electric field of a second frequency band sensitive to the detection of an aerosol generating material may be applied to the second capacitive sensor.

Operation 1004 of determining whether the aerosol generating article is reused based on the capacitance variances may further include operation of determining that the aerosol generating article is in an over-humidified reused state when the capacitance variance measured by the first capacitive sensor is greater than a first set value and the capacitance variance measured by the second capacitive sensor is greater than a second set value.

Operation 1004 of determining whether the aerosol generating article is reused based on the capacitance variances may further include operation of determining that the aerosol generating article is in a normal reused state when the capacitance variance measured by the first capacitive sensor is less than the first set value and the capacitance variance measured by the second capacitive sensor is greater than a third set value.

The descriptions of the above-described embodiments are merely examples, and it will be understood by one of ordinary skill in the art that various changes and equivalents may be made thereto. Therefore, the scope of the disclosure should be defined by the appended claims, and all differences within the scope equivalent to those described in the claims will be construed as being included in the scope of protection defined by the claims.

What is claimed is:

1. An aerosol generating device comprising:
a housing including a first surface, a second surface that is opposite to the first surface, and a side surface between the first surface and the second surface, wherein an inner space into which an aerosol generating article is inserted is formed on the first surface;
a first sensor disposed adjacent to the inner space;
a second sensor disposed adjacent to the inner space at a position different from that of the first sensor; and
a controller that is accommodated by the housing and comprises at least one processor,
wherein the controller is configured to determine whether the aerosol generating article is over-humidified based on first information received from the first sensor and determine whether the aerosol generating article is reused based on second information received from the second sensor.

2. The aerosol generating device of claim 1, wherein electric fields of different frequency bands are applied to the first sensor and the second sensor.

3. The aerosol generating device of claim 2, wherein an electric field of a first frequency band that is sensitive to moisture detection is applied to the first sensor.

4. The aerosol generating device of claim 2, wherein an electric field of a second frequency band that is sensitive to detection of an aerosol generating material is applied to the second sensor.

5. The aerosol generating device of claim 2, wherein the controller is configured to apply an electric field to the first sensor, and, after stopping the application of the electric field to the first sensor, sequentially apply an electric field to the second sensor.

6. The aerosol generating device of claim 2, wherein
the inner space comprises an inner space end surface positioned between the first surface and the second surface and an inner space side surface extending from an edge of the inner space end surface to the first surface, and
the first sensor and the second sensor are arranged sequentially along a direction from the first surface toward the inner space end surface.

7. The aerosol generating device of claim 6, wherein the first sensor comprises a first capacitive sensor, and the second sensor comprises a second capacitive sensor.

8. The aerosol generating device of claim 7, wherein the controller is configured to determine that the aerosol generating article is in an over-humidified state if a capacitance variance measured by the first capacitive sensor is greater than a first set value.

9. The aerosol generating device of claim 8, wherein, when the aerosol generating article is determined to be in the over-humidified state, the controller is configured to determine that the aerosol generating article is in an over-humidified reused state if a capacitance variance measured by the second sensor is greater than a second set value.

10. The aerosol generating device of claim 8, wherein, when the aerosol generating article is determined to be in a non-over-humidified state, the controller is configured to determine that the aerosol generating article is in a normal reused state if a capacitance variance measured by the second sensor is greater than a third set value.

11. A method of determining a state of an aerosol generating article, the method comprising:
providing the aerosol generating article comprising a first filter segment, a medium segment that is disposed in a downstream of the first filter segment and configured to accommodate a medium, and a second filter segment that is disposed in a downstream of the medium segment;
measuring a capacitance variance of the medium segment of the aerosol generating article by a first capacitive sensor;
measuring a capacitance variance of the first filter segment by a second capacitive sensor; and
determining whether the aerosol generating article is reused based on the capacitance variances.

12. The method of claim 11, wherein an electric field of a first frequency band sensitive to moisture detection is applied to the first capacitive sensor.

13. The method of claim 12, wherein an electric field of a second frequency band sensitive to detection of an aerosol generating material is applied to the second capacitive sensor.

14. The method of claim 11, wherein the determining whether the aerosol generating article is reused based on the capacitance variances further comprises:
determining that the aerosol generating article is in an over-humidified reused state when the capacitance variance measured by the first capacitive sensor is greater than a first set value and the capacitance variance measured by the second capacitive sensor is greater than a second set value.

15. The method of claim 11, wherein the determining whether the aerosol generating article is reused based on the capacitance variances further comprises:
determining that the aerosol generating article is in a normal reused state when the capacitance variance measured by the first capacitive sensor is less than the first set value and the capacitance variance measured by the second capacitive sensor is greater than a third set value.
